(19) United States
(12) Patent Application Publication
(10) Pub. No.: US 2007/0136278 A1
(43) Pub. Date: Jun. 14, 2007

(54) Computer network

(76) Inventors: Daniele Grazioli, Weyhill (GB); Elena Pasquali Grazioli, Weyhill (GB)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 10/577,364

(22) PCT Filed: Oct. 29, 2004
(86) PCT No.: PCT/GB04/04578

§ 371 Date: Jul. 12, 2006

(30) Foreign Application Priority Data
Oct. 31, 2003 (GB) 0325417.4

(51) Int. Cl. G06F 17/30

(52) U.S. Cl. 707/6

(57) ABSTRACT

A computer network (1) for processing received event data, the computer network comprising a grid of data processors (2), each data processor being provided with a node management program, the computer network further comprising shared data storage means (3) which is accessible and shared by the data processors, the shared data storage means being provided with (a) declaration data which is representative of where data objects are stored, and whether data objects resulting from processing of incoming event data are to be stored and where such data objects are to be stored, (b) event algorithms and (c) a look-up table which indicates which event algorithm is associated with (i) a category of agent originating the event data and/or (ii) a category of event, a data processor being such that, in use, the node management program determines (i) the category of agent which originated the event data and/or (ii) the category of the received event data, retrieves declaration data from the shared data storage means, by use of the look-up table determines a respective event algorithm which is associated with (i) the category of the agent which originated the event data and/or (ii) the category of event data, the node management program also being operative to call data objects required by the selected event algorithm, the node management program locating said data objects in said shared data storage means from location data included in the declaration data, and the node manager program being operative to store any data objects resulting from the execution of the algorithm which are to be stored as required by the declaration data, in one or more respective locations in the shared data storage means as determined by the declaration data.

The present invention relates to computer networks and in particular, but not exclusively, to a network of computers for processing on-line transactions.

According to a first aspect of the invention there is provided a computer network for processing received event data, the computer network comprising a plurality of data processors, each data processor being provided with a node management program, the computer network further comprising shared data storage means which is accessible and shared by the data processors, the shared data storage means being provided with (a) declaration data which is representative of where data objects are stored, and whether data objects resulting from processing of event data are to be stored and where such data objects are to be stored, (b) event algorithms and (c) a look-up table which indicates which event algorithm is associated with (i) a category of agent originating the event data and/or (ii) a category of event, a data processor being such that, in use, the node management program determines (i) the category of agent which originated the event data and/or (ii) the category of the received event data, retrieves declaration data from the shared data storage means, by use of the look-up table determines a respective event algorithm which is associated with (i) the category of the agent which originated the event data and/or (ii) the category of event data, the node management program also being operative to call data objects required by the selected event algorithm, the node management program locating said data objects in said shared data storage means from location data included in the declaration data, and the node manager program being operative to store any data objects resulting from the execution of the algorithm which are to be stored as required by the declaration data, in one or more respective locations in the shared data storage means as determined by the declaration data.

The term ‘event data’ is used herein to include a signal which is sent to a data processor in respect of one or more prospective data processing operations.

In a preferred embodiment of the invention an event is an on-line transaction request sent by a client to a network of inexpensive computers.

Data objects are preferably objects of data which an event algorithm is required to process/act on.

A data object may comprise a plurality of subsidiary data objects.

The expression ‘computer network’ should be understood to include at least two computers which are able to communicate via a communication link and includes, for example, the Internet and Local Area Networks.

Preferably the declaration data is loaded onto a local memory of the data processor before an event algorithm is determined and then called.

The declaration data preferably comprises a dictionary of characteristics of all data objects within the network.

The look-up table is preferably stored in a part of the shared data storage means which is remote from the data processors, and the data processors communicating with that part of the shared data storage means by an external connection. The algorithms are preferably stored in a part of the shared data storage means which is remote from the data processors, and the data processors communicating with that part of shared data storage means by an external connection. Desirably that part of the shared data storage means which is read-only memory.

Data objects are preferably stored in a part of the shared data storage means which is remote from the data processors, and the data objects resulting from the execution of the algorithm which are required to be stored by the declaration data, in a respective location as also determined by the declaration data.

Preferably that part of the shared data storage means which contains objects which are not alterable as a result of an event algorithm is a read-only memory, and part which contains objects which may be modified as a result of an algorithm is a re-writable memory.

Preferably the data processors communicate with the shared data storage means by an external connection.

In a preferred embodiment, each business event algorithm represents a process which is implemented as a configurable sequence of re-usable processing units (business rules) automatically applied by the apparatus to an incoming event. The sequence of business rules with which a business process is configured defines the execution order of the business rules. A business rule is preferably re-usable because several different business processes may be configured using the same set of business rules.

The network provides the execution framework so that all the operations of the event algorithms constituting an event algorithm being applied to event data are part of a single transaction. To process event data, depending on the content of the event data, one or several different event algorithms, or several parts of different event algorithms, can be executed by the network.

In a preferred embodiment of the invention, an event algorithm comprises one or more C/C++ functions implemented into a Dynamic Link Library or a Run Time Shared Library.

The event algorithms are preferably of two main categories: solution rules and infrastructure rules. In a preferred embodiment the solution rules contain logic required by the specific solution they support while the infrastructure rules are meant to implement logic required for the management of user errors, system exceptions and external transactions. The infrastructure rules are executed asynchronously by each data processor apparatus, ie their execution order does not depend on the sequence with which an event algorithm has been configured. In a preferred embodiment, there are four main types of infrastructure rules: on_error, on_exception, on_commit and on_rollback. Respectively, they are meant to support user error management, system exception management and transaction coordination (commit and rollback) with any external resource manager. The infrastructure rules on_commit and on_rollback are not needed for internal transactions ie in such case the apparatus automatically support the ACID (Atomicity, Consistency, Isolation, Durability) properties to be exhibited by the transaction itself.

The expression ‘external transaction’ relates to any transaction initiated by one or more event algorithms (being activated to process the incoming event) toward any external resource manager.

The expression ‘internal transaction’ relates to any transaction initiated by one or more event algorithms (being activated to process the incoming transaction request) that access only persistent data managed by the persistence providers within the network.

Each data processor is preferably configured to declaration data which is representative of all the defined data objects included in sequences of business rules defining all the available event algorithms. In one embodiment of the invention the declaration data is formalized based on a syntax.

Preferably all data objects to be acted on by the event algorithm are stored in a local memory of the data processor which comprises a memory stack which is adapted to be accessible by the algorithm. In a preferred embodiment the stack is a type of cache memory.

Most preferably said data obtained by the node management program from the data storage means comprises most of the data which is to be acted upon by the event algorithm, which is in addition to the data included in the event.

The expression ‘resource manager’ relates to a system (external to the network of the invention) that can participate in coordinated operations/transactions. Such systems typically (but not only) expose an interface based on the 2PC (2 phases commit)/XA standard paradigm.

The computer network may be viewed as a domain in which the data processors all hosting the same set of event algorithms (business processes), all having access to the same set of persistence providers, all having access to the same set of lock managers and all having access to the same internal bus.

Each instance of a given class of a data object may be stored on several different persistence providers of the shared data storage means and/or all the instances of different classes of data objects can be ‘stored’ on several different persistence providers. For example, each instance of the class A can be stored into the persistence providers X and Z where X provides persistence to the part A1 of the properties of the class A and Z provides persistence to the part A2 of the properties of the class A and/or each class can have its own set (one or more) of persistence providers. This may be viewed as the partitioning of a persistent data object (global objects) over a multitude of heterogeneous and parallel persistence providers. Parallel persistence providers are a set of processors, typically driving third party database engines, that provide persistence to any persistent objects. The persistence providers are ‘parallel’ because no persistence provider is aware of any other persistence provider within a domain.

The network is desirably configured to provide determinism amongst a multitude of computers that may have concurrent access to the same set of global (shared) data objects.

In a domain (a partition of a multitude of data processors), each node management program of a data processor hosting a set of event algorithms (business processes) is preferably not aware of any other node manager program or another data processor agent within the same domain. This enormously simplifies the configuration of a domain but introduces several issues whenever, based on a set of incoming events, more than one node manager program has to trigger one or more business processes resulting in a non volatile change of the same global (shared) data object.

For instance, two or more node management programs might produce an impact over the same data object eg an account balance. In all these cases, to guarantee a deterministic environment, it is essential to provide an external coordination (or synchronization) amongst the node management programs themselves. Such coordination (or synchronization) is preferably provided not based on the logic that is going to be triggered but on the global (shared) data objects that might be the target of the triggered logic or business processes. In this way it is possible to guarantee maximum concurrency (several instances of the same event algorithm (business process) can be initiated in parallel by several node management programs when the global target data differ) and determinism (whenever several instances of the same business process or several instances of different business processes have the same global target data objects, the business processes are synchronized).

The computer network preferably comprises at least one lock manager processor which is connected to the data processors, and are configured to control use and modification of predetermined data objects requested by the data processors. Preferably access to those data objects which are intended to be modified/updated by an event algorithm is controlled by the lock manager processor which is operative to allow access to one such data object by only one data processor at any one time.

The lock manager processors have the role to coordinate the access to any global data object as performed by any processing node manager agent by the mean of a first memory volatile queue containing pending locks and granted locks. The lock manager processors therefore preferably provide determinism over a plurality of computers at least some of which may attempt to access a shared data object at the same time.

Whenever the status of a lock (eg from pending to granted) changes, it is responsibility of the lock manager processor to notify the owner of the previously pending lock (a node manager processor), so that the owner of the lock can continue with the processing of the event algorithm that has lead to the lock over a global data object. In one embodiment of the invention it is responsibility of the node manager program to: notify a lock request to the lock manager processor, notify the release of a lock to the lock manager processor, notify a lock-set request to the lock manager. It is desirably the responsibility of the lock manager processor to maintain a queue of pending locks, granted locks and pending lock-sets. It is desirably the responsibility of the lock manager processor to notify the node managers when a lock or a lock-set changes its status, eg from pending to granted.

As a preferred embodiment of the invention, a lock-set is defined as a transactional unit containing several lock requests. The lock requests within a lock-set can be granted only if all the lock requests contained into the lock set can be granted.

Any lock manager processor may preferably be configured to set up a given maximum time for the status of a lock to change from pending to granted. If the total amount of time expires it is responsibility of the lock manager to notify the node manager requesting the lock with such condition.

In one embodiment of the invention each lock manager unit within the multitude of computers has access to an internal bus through which an event is presented to the multitude of computers.

In one embodiment of the invention the plurality of data processors can be configured so that each lock manager unit has one or more backup units providing automatic fail-over should a lock manager fail. The automatic fail-over of the shared lock managers is intended to eliminate any single point of failure from the apparatus.

In one embodiment of the invention, each unit within the multitude of computers has access to a set of specialized software agents synchronizing any access to any global (shared) resource amongst the multitude of computers. In the first embodiment of the invention each unit within the multitude of computer might have access to a set of specialized agents providing persistence to any global (shared) data object required by the logic (or set of business processes) hosted by the multitude of computers.

The multitude of computers may be partitioned in several domains.

In one embodiment of the invention, the node manager program continues the processing of an event algorithms (business process) only if all the requested locks have been granted. It is responsibility of the node manager program to rollback any operation initiated by the event algorithm if any of the requested lock cannot be obtained.

A lock is preferably viewed as a reference to a single data object, as identified by an associated unique identifier.

Within a same domain it is desirably possible to distribute the computational load due to lock management over several lock managers. In a preferred embodiment of the invention such distribution is provided partitioning the lock requests by classes of data objects for which the lock manager processors have to maintain the global locks. The partitioning of the computational load related to global lock management is guaranteed by a configuration repository of which each node manager program within the same domain has to be aware.

Preferably the data processors (or nodes), lock manager processors and data storage means (or repositories) communicate with each other by way of an internal bus ie one or more computer programs based on store and forward technology that can participate in operations caused by a received event.

According to a second aspect of the invention there is provided a data processor for a network of computers which is configured to receive and process received event data, the data processor being provided with a node management program, and the data processor being configured to be linked to shared data storage means which is shared by a least one other such data processor of the network of computers, the data storage means being provided with (a) declaration data which is representative of where data objects are stored, whether data objects resulting from processing of event data are to be stored and where such data objects are to be stored in the shared data storage means, (b) event algorithm and (c) a look-up table which indicates which event algorithm is associated with (i) a category of agent originating the event data and/or (ii) a category of event, the data processor being such that, in use, the node management program determines (i) the category of agent which originated the event data and/or (ii) the category of the received event data, retrieves declaration data from the shared data storage means, uses the look-up table to determine a respective event algorithm which is associated with (i) the category of agent that originated the event data and/or (ii) the category of event data, the node management program also being operative to call data objects required by the selected event algorithm from one or more locations in the shared data storage means as stated in the declaration data, and the node management program being operative to store any data objects resulting from the execution of the event algorithm which are to be stored as required by the declaration data, in one or more respective locations in the shared data storage means as determined by the declaration data.

According to a third aspect of the invention there is provided a machine readable data carrier which is provided with instructions to implement a node management program on a data processor in a computer network, the computer network comprising a plurality of such data processors, the computer network further comprising shared data storage means which is accessible and shared by the data processors, the shared data storage means being provided with (a) declaration data which is representative of where data objects are stored in the shared data storage means, and whether data objects resulting from processing of received event data are to be stored and where such data objects are to be stored, (b) event algorithms and (c) a look-up table which indicates which event algorithms is associated with (i) a category of agent which originated the event data and/or (ii) the category of the received event data, the node management program being operative to cause a data processor to determine (i) the category of agent which originated the event data and/or (ii) the category of the event data, and accordingly determine an associated event algorithms from the look-up table, the node management program being operative to call the declaration data and the node management program being operative to call data objects from the shared data storage means which objects are required by the event algorithms, the node manager program locating said data objects in said shared data storage means from location data included in the declaration data, and the node management program causing data objects resulting from the execution of the event algorithms which are to be stored in accordance with the declaration data in a respective location as determined by the declaration data.

According to a fourth aspect of the invention there is provided a method of processing received event data comprising causing a data processor from a network of data processor to determine (i) a category of agent which originated the event data and/or (ii) a category of the event data, determining a respective event algorithms by means of a look-up table which indicates which event algorithms is associated with (i) and/or (ii), to retrieve from shared data storage means, which data storage means is shared by the data processors, declaration data which is representative of where data objects are stored in the shared data storage means, to retrieve the selected event algorithms from the shared data storage means, to call data objects required for execution of the event algorithms from the shared data storage means from one or more locations determined by the declaration data, and, to store any data objects resulting from execution of the algorithms which are to be stored as required by the declaration data in one or more locations in the shared data storage means determined by the declaration data.

A highly preferred embodiment of the invention may be viewed as a run-time embodiment that facilitates the development of highly distributed computer environment solutions by letting a developer assume that the solution (algorithm) will be executed in a single-threaded environment whilst, based on different deployment configurations, it is actually executed onto a set of parallel, multi-threaded processors without losing the determinism typical of a single-threaded processor. Also, the algorithm can be developed using highly popular and standard third party products, not requiring any specialized compiler.

Various embodiments of the invention will now be described, by way of example only, with reference to accompanying Figures, in which:

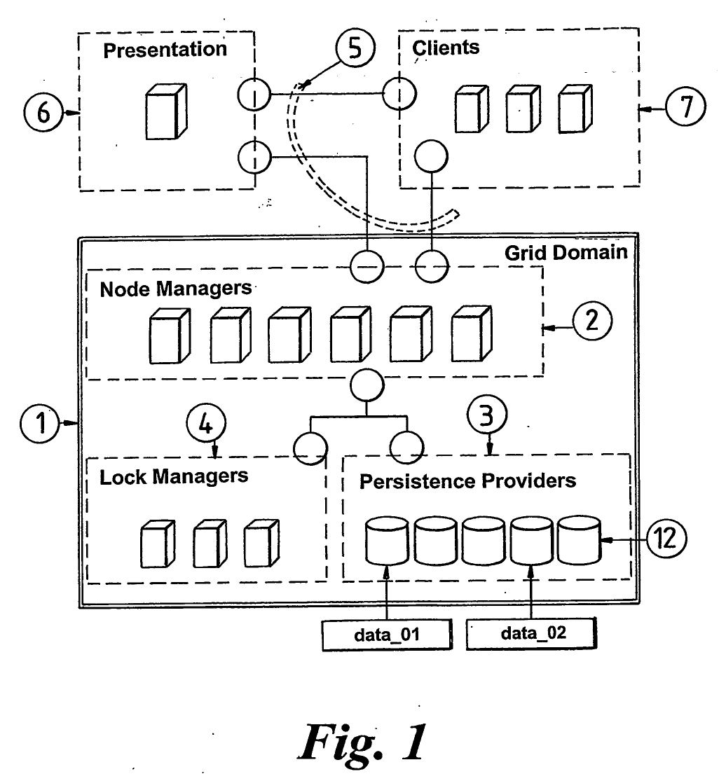

FIG. 1 is a block diagram of the apparatus,

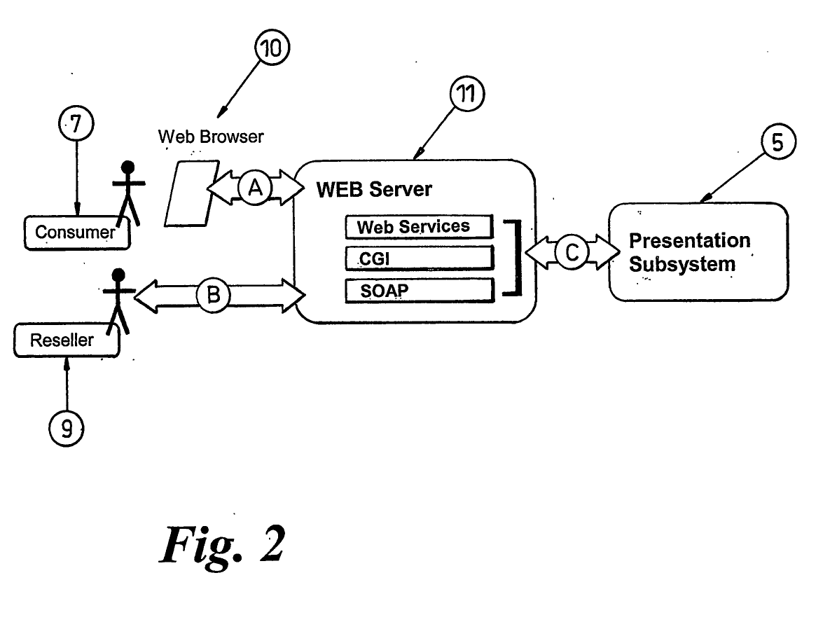

FIG. 2 is a block diagram of some possible messaging arrangements between clients (the agents present the transaction requests) and the apparatus,

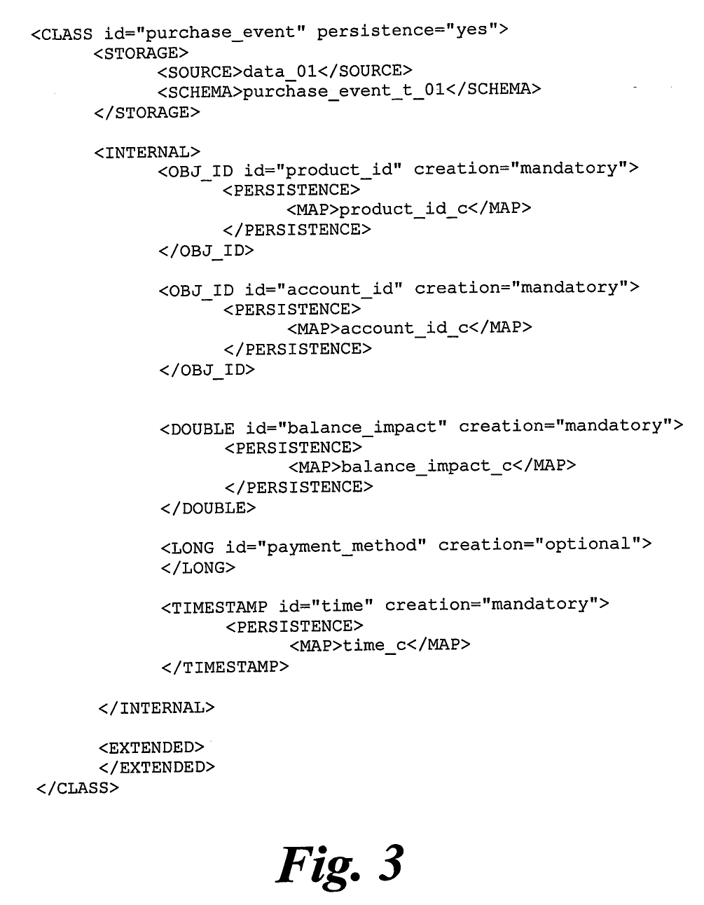

FIG. 3 is a code listing of a declaration of a purchase event (purchase transaction request) that exemplifies the declaration of a class of events,

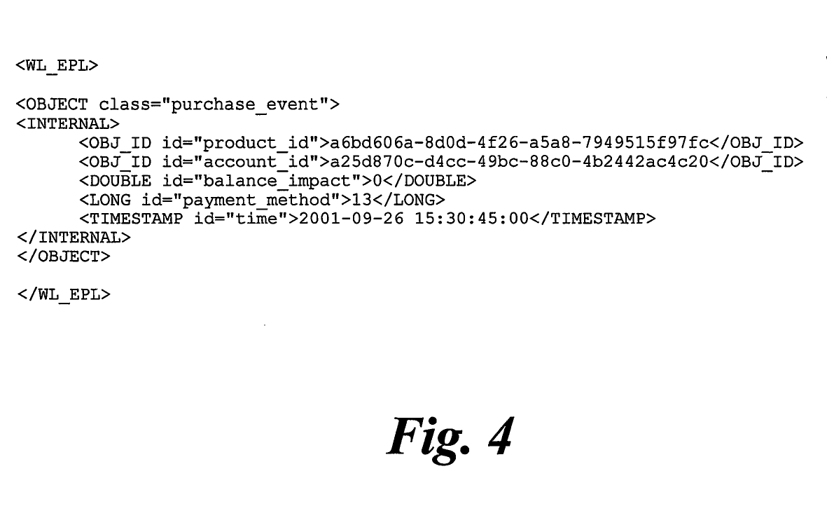

FIG. 4 is a code listing that exemplifies the instantiation of a class of events,

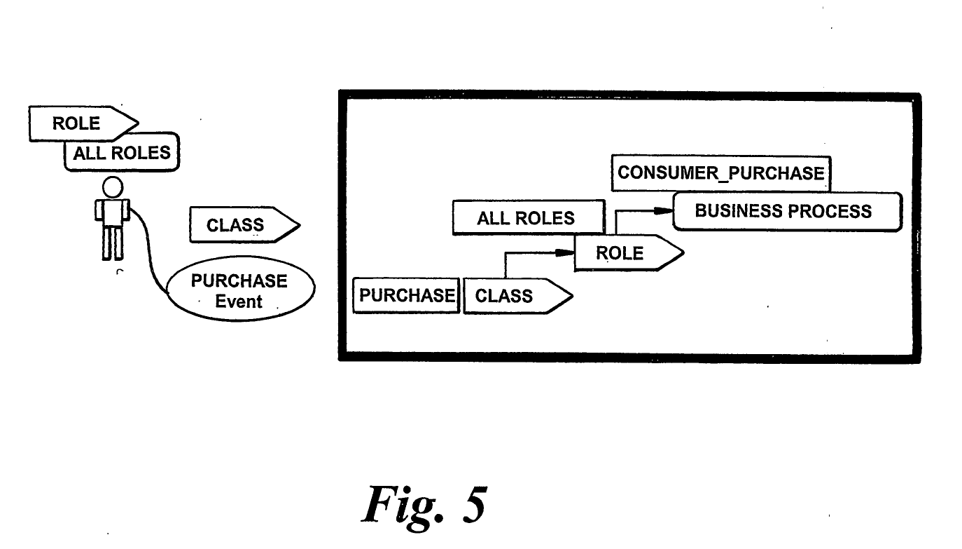

FIG. 5 is a block diagram which illustrates binary associative logic,

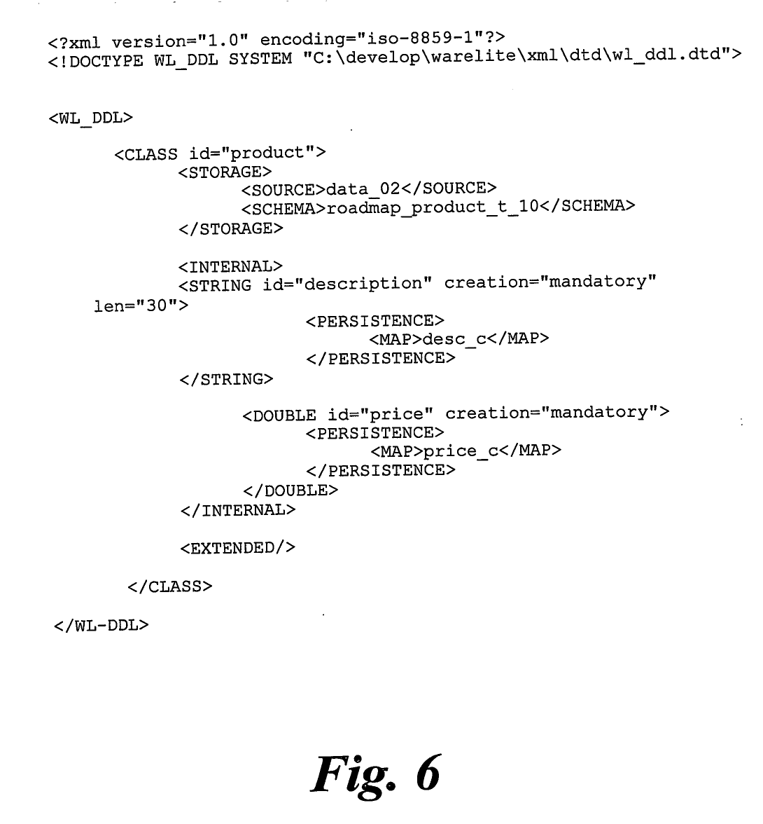

FIG. 6 is a code listing of a declaration of the product class of objects,

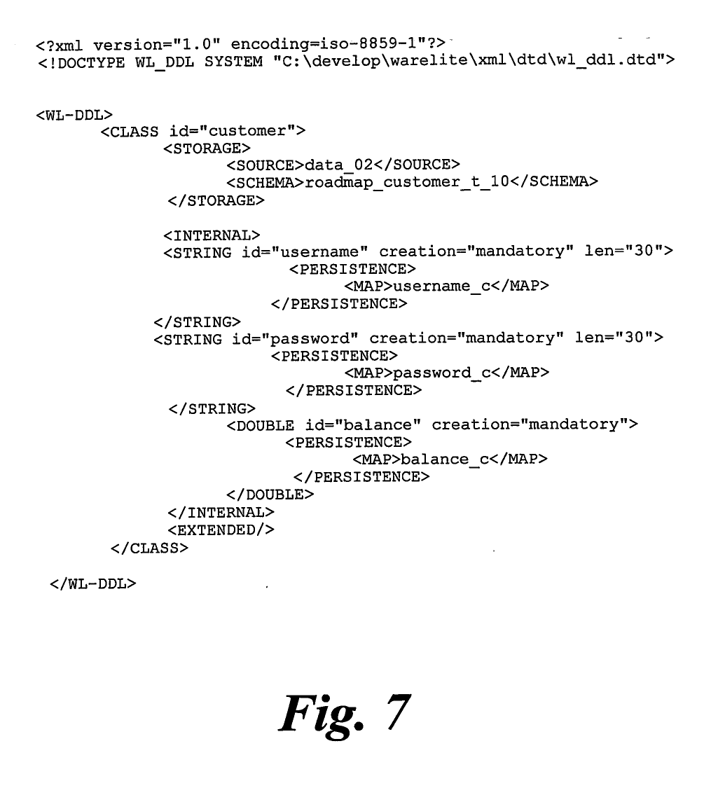

FIG. 7 is a code listing of a declaration of the customer class of objects,

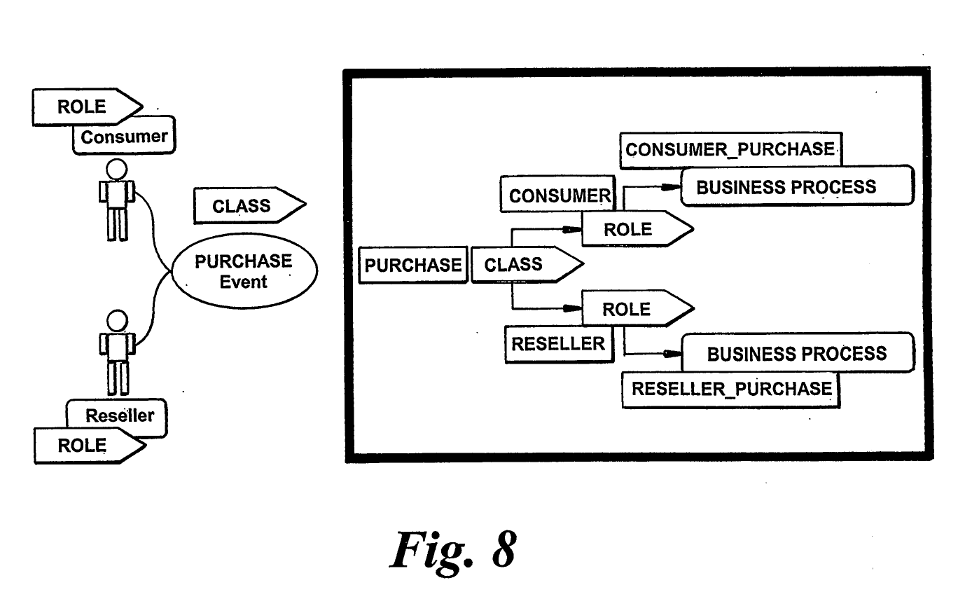

FIG. 8 is a block diagram which illustrates ternary associative logic,

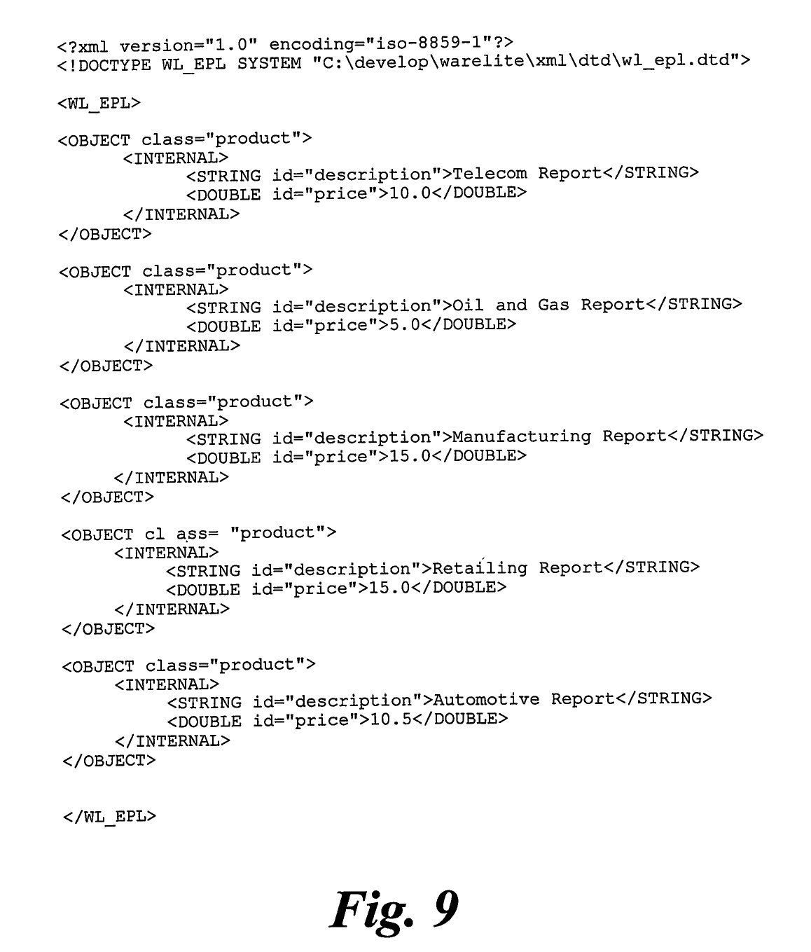

FIG. 9 is a code listing of various instances of the class product that exemplifies a single transaction containing several instances of a class of events,

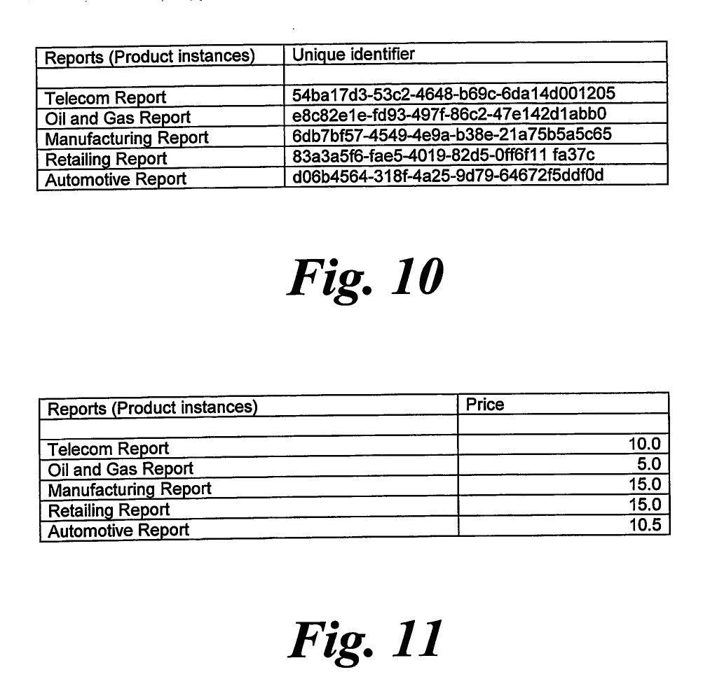

FIG. 10 is a table showing the unique identifiers assigned to each product instance, accordingly to the example application,

FIG. 11 is a table showing the prices assigned to each product instance, accordingly to the example application,

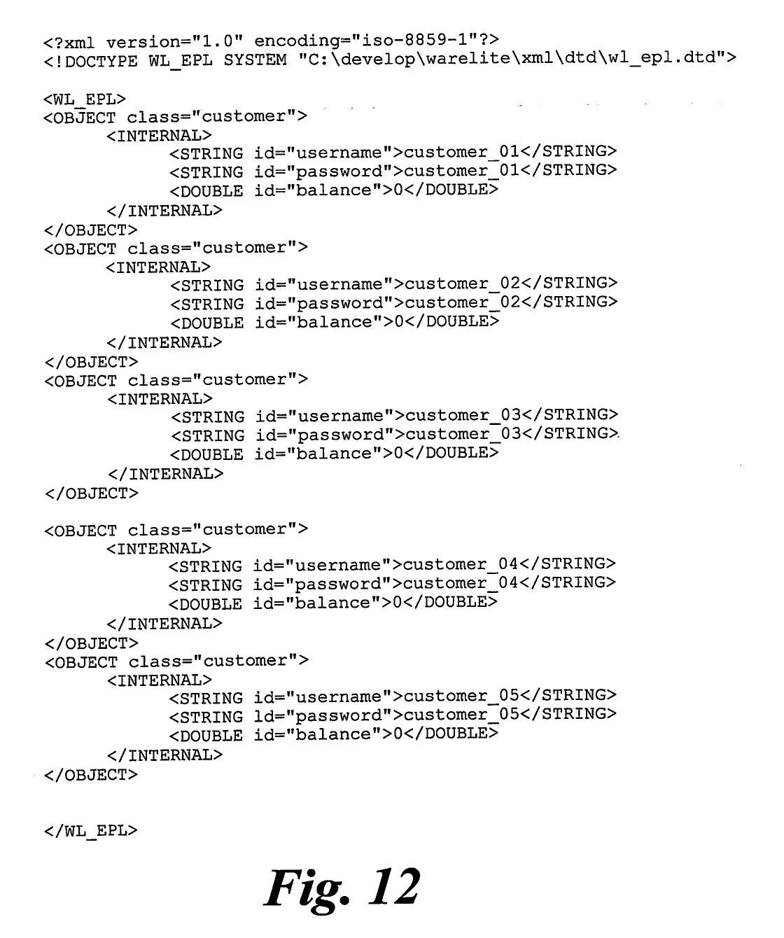

FIG. 12 is a code listing of various instances of the class customer,

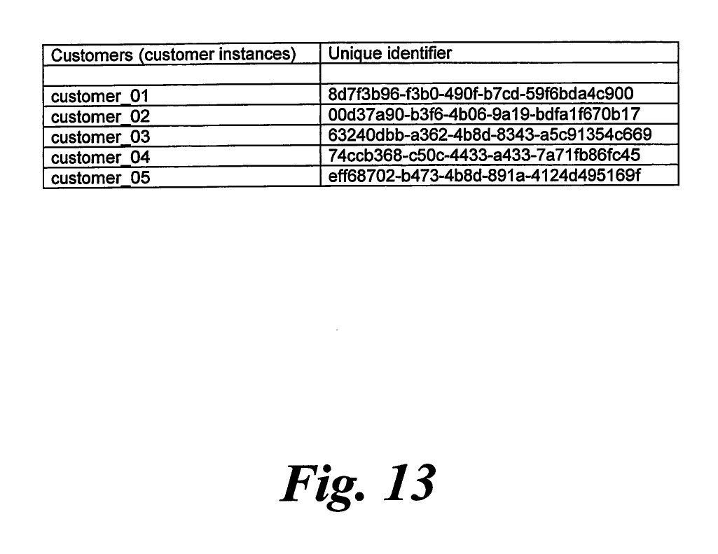

FIG. 13 shows a table of unique object identifiers assigned to each customer, accordingly to the example application,

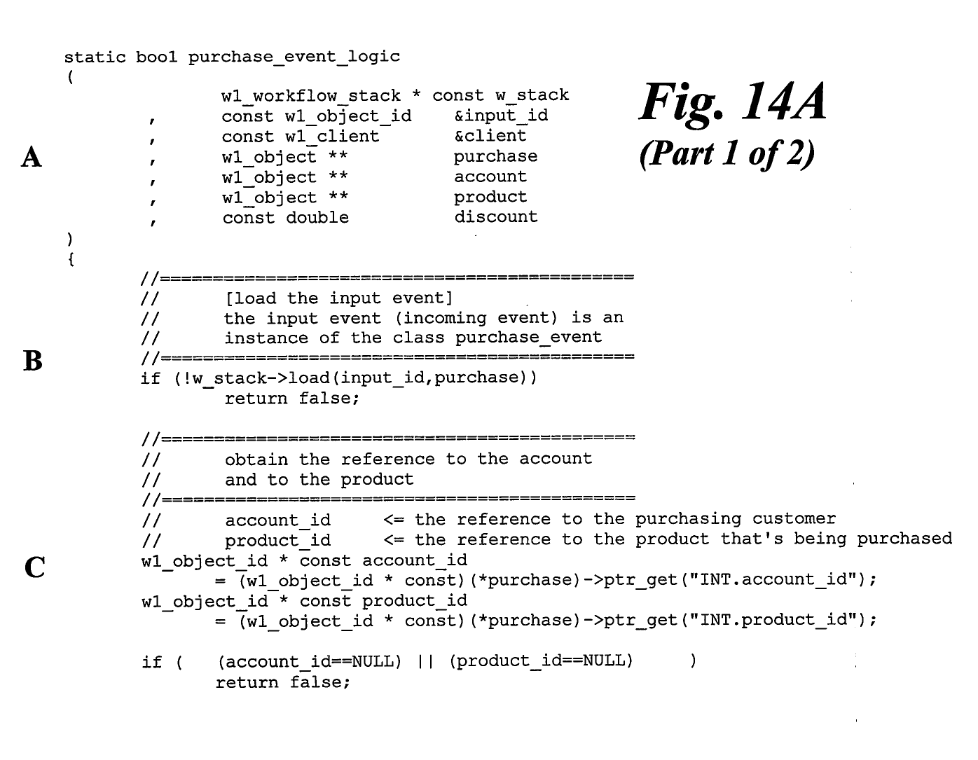

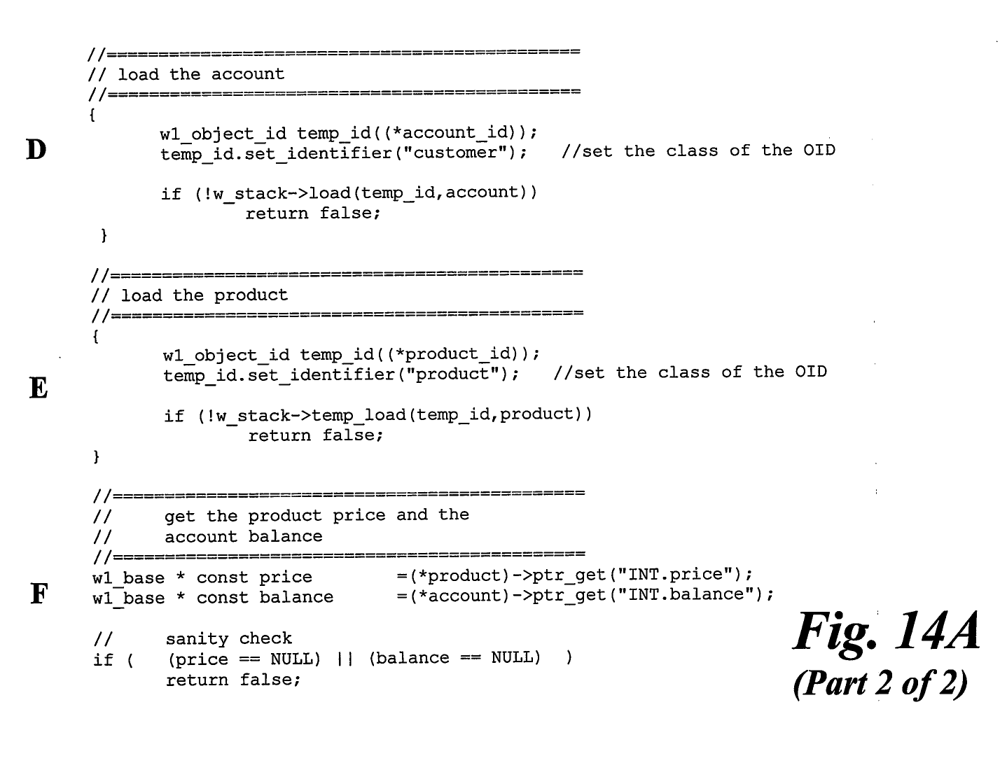

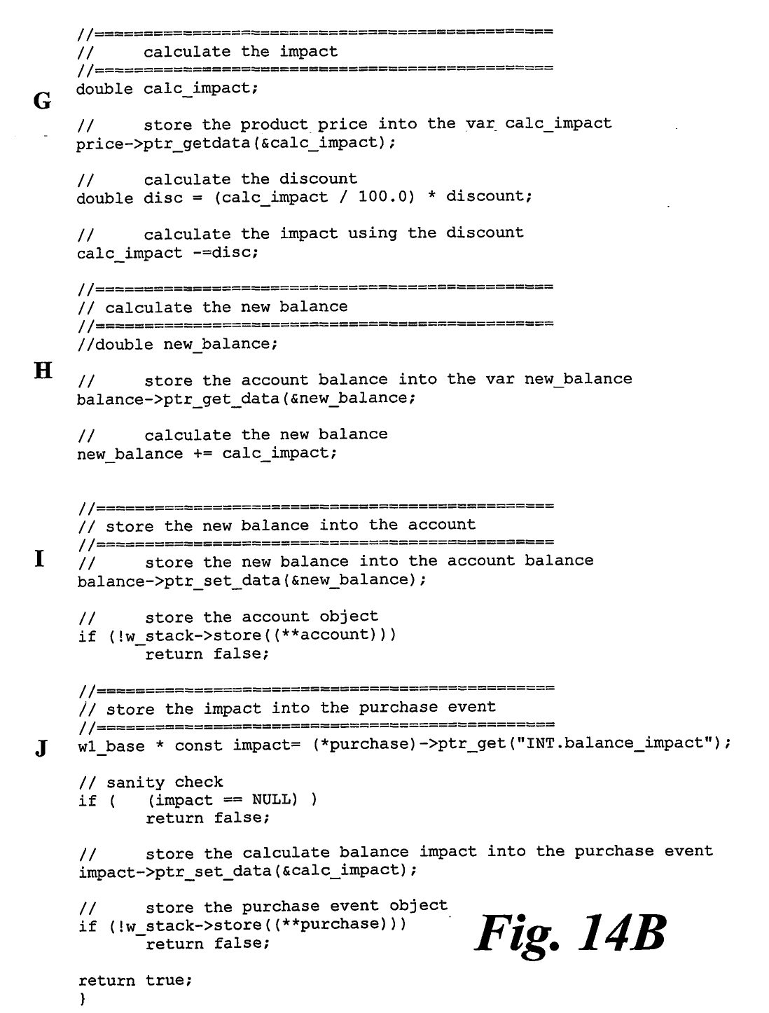

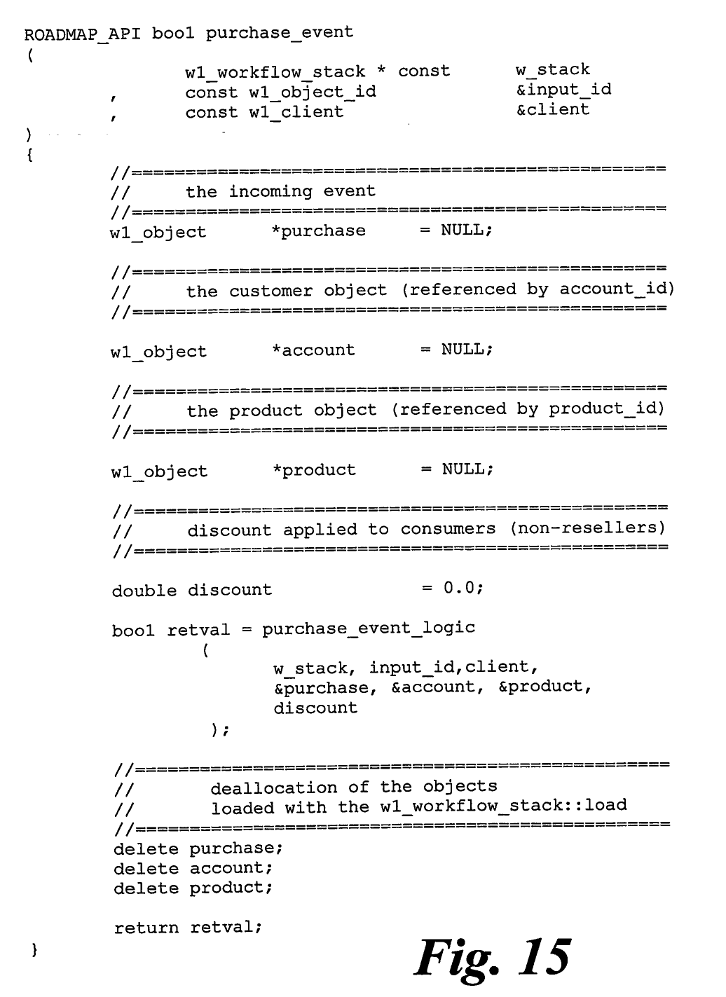

FIGS. 14A and 14B show a code listing that exemplifies the logic that might be contained into a business rule, according to the interfaces defined toward the apparatus,

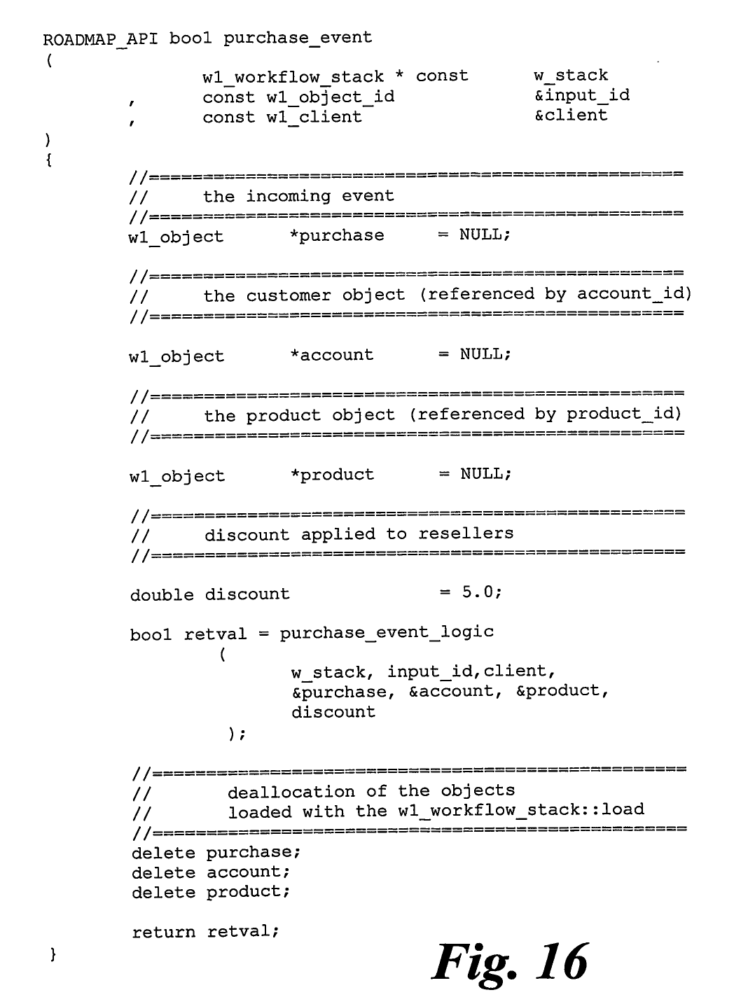

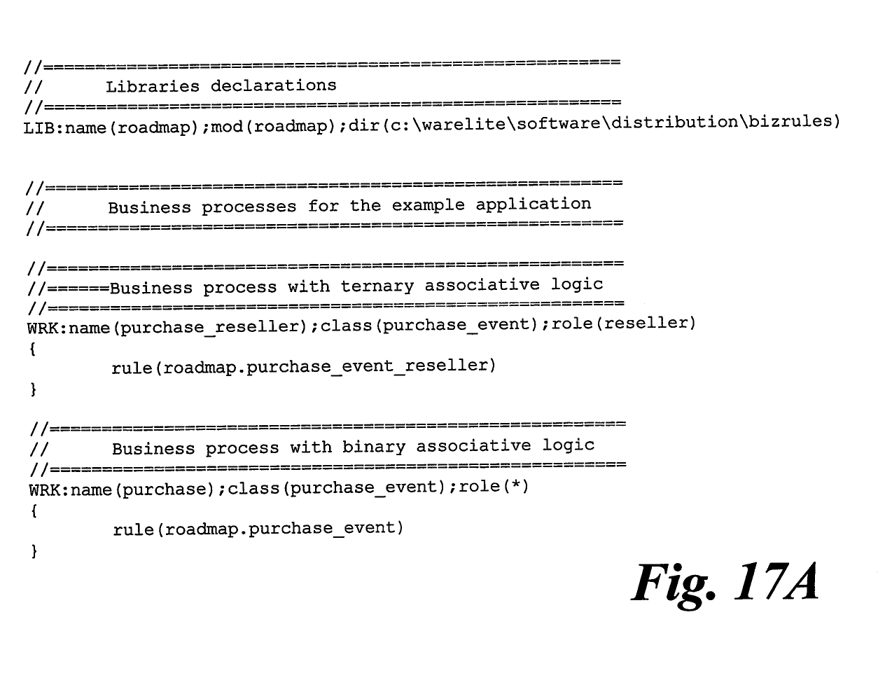

FIG. 15 is a code listing that exemplifies a business rule to be applied when a consumer presents a purchase event to the apparatus, accordingly to the example application,

FIG. 16 is a code listing that exemplifies a business rule to be applied when a reseller presents a purchase event to the apparatus, accordingly to the example application,

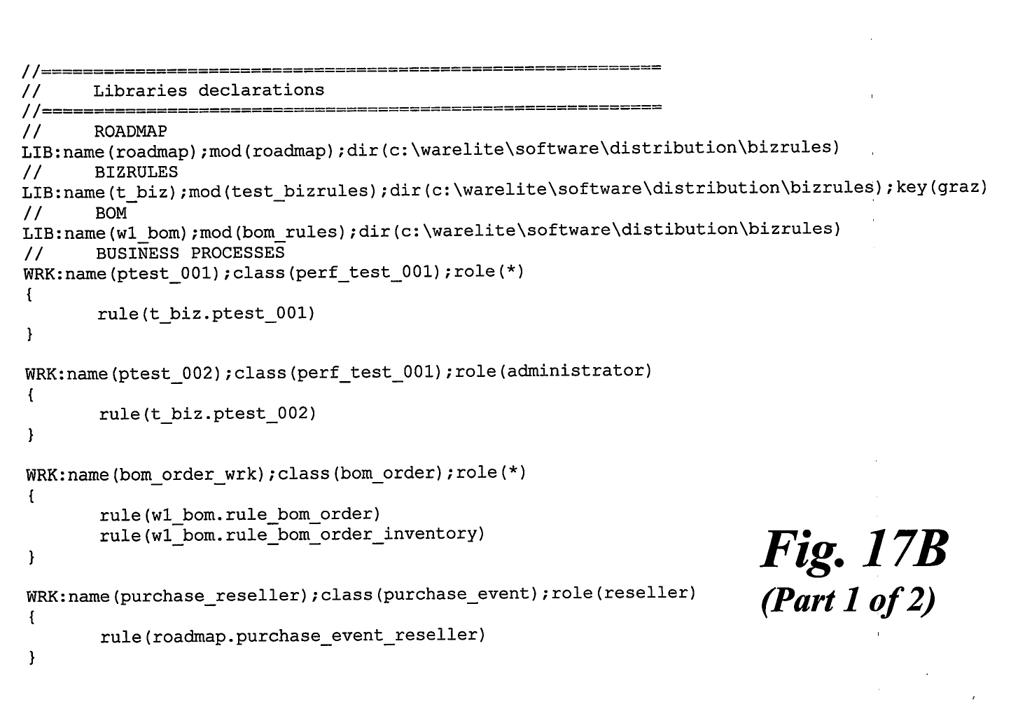

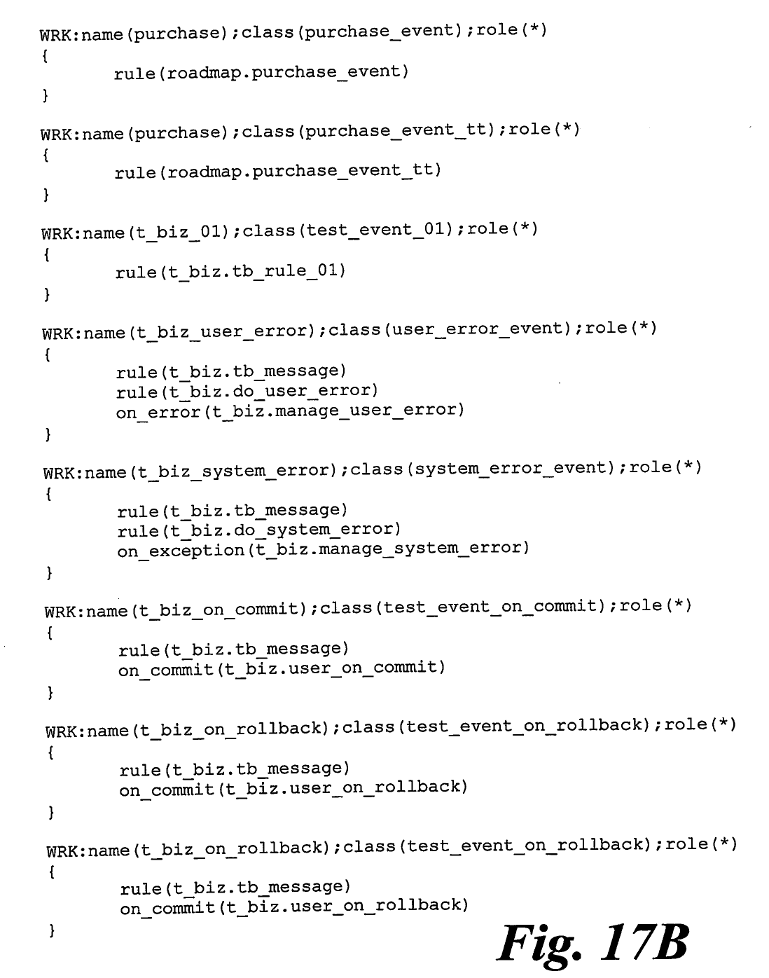

FIGS. 17A and 17B are code listings that exemplifies the configuration of business processes with binary and ternary associative logic,

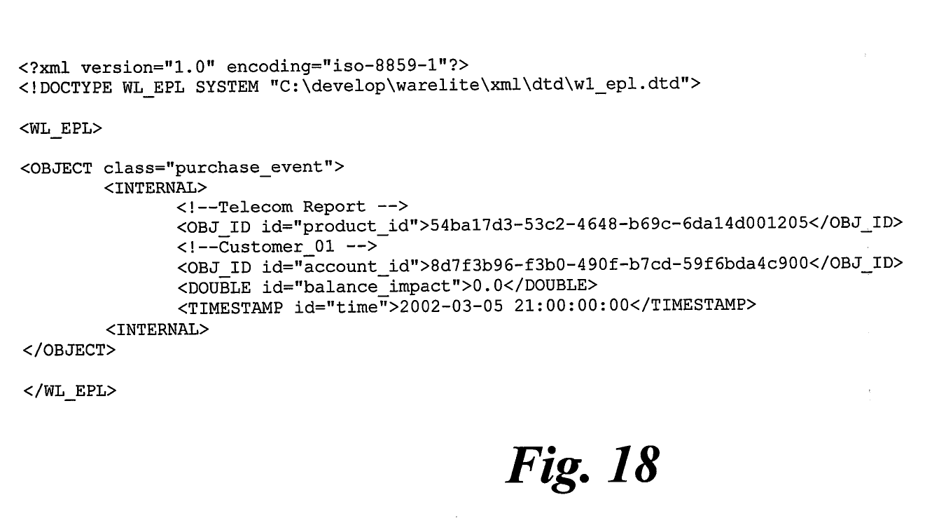

FIG. 18 is a code listing that exemplifies a purchase event frame in which a customer has requested a report,

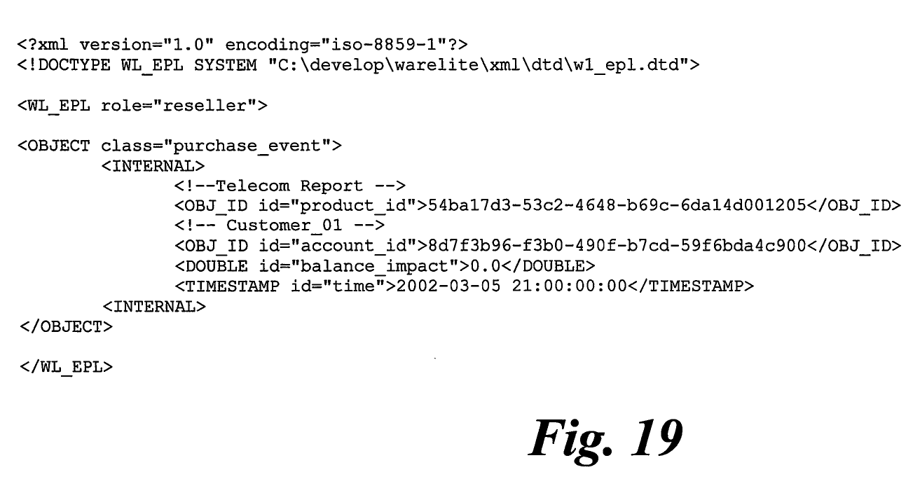

FIG. 19 is a code listing that exemplifies a purchase event frame similar to that of FIG. 18 but in which the customer is impersonating the reseller role,

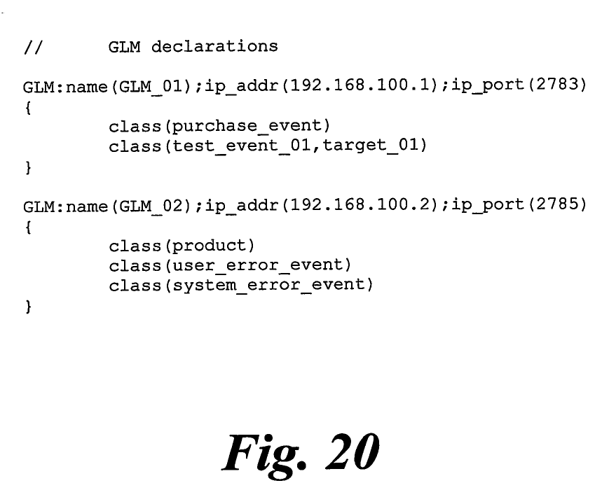

FIG. 20 is an example of the syntax used to partition the global lock requests over a multitude of lock managers within the same domain,

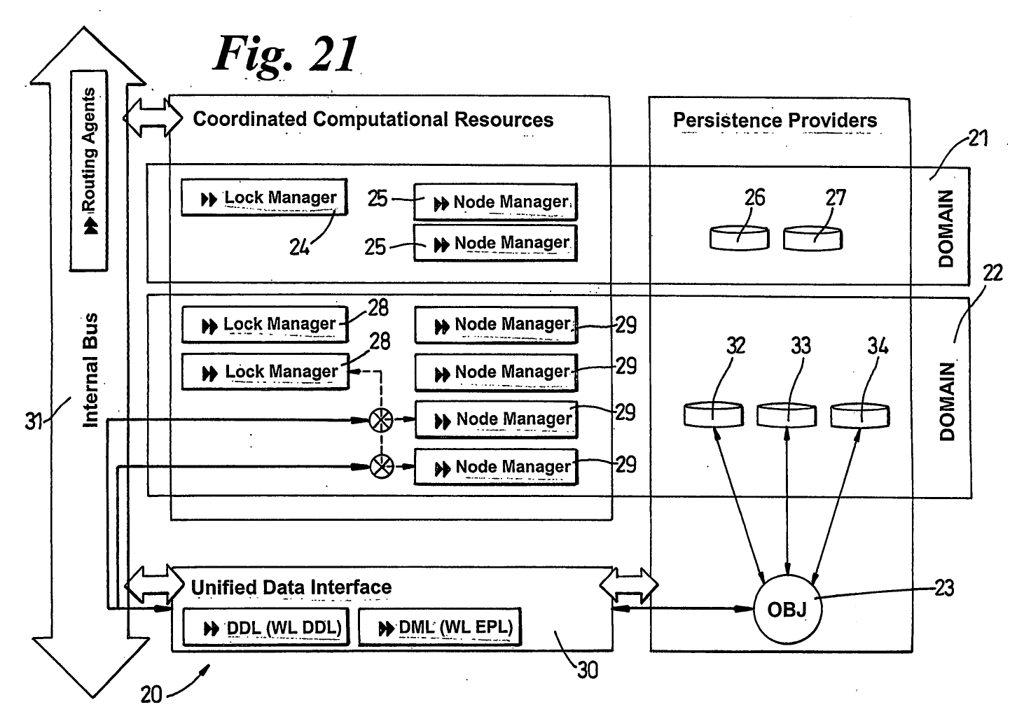

FIG. 21 is a schematic diagram of a further implementation of the invention, and

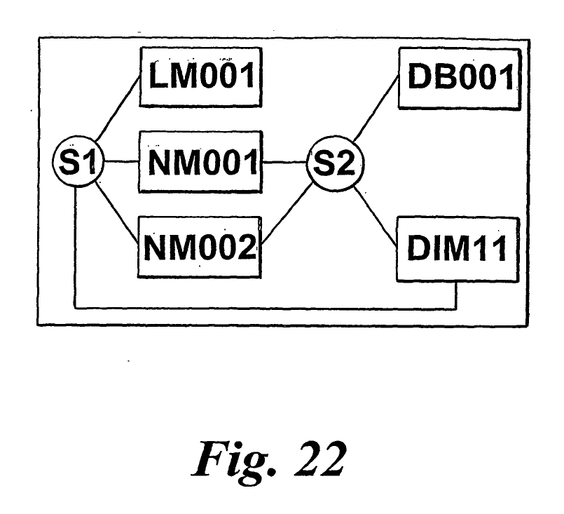

FIG. 22 is a block diagram of a test equipment used to run an example application.

With reference to FIG. 1 there is shown a domain 1 comprising a plurality of node managers 2 which form a servers' farm, a plurality of persistence providers 3 and a plurality of global lock managers 4. The domain 1 is connected by a telecommunication network 5 to a presentation server 6 and a plurality of client computers 7. The domain 1 is configured to handle and respond to transaction requests sent by a client computer 7 via the presentation server 6.

The domain 1 is provided by a collective of node managers 2 providing the main processing units, each node manager being provided by a computer running the software node manager which comprises workflow manager software for the transactional processing of any defined business process. The persistence providers 3 are connected to the node managers 2 and are DBMS which store global (persistence) objects. The node managers 2 are also connected to the global lock managers 4 which are server components configured to provide determinism amongst incoming concurrent transaction requests that might impact on global objects. Also, the global lock managers 4 (provided by the servers) are meant to avoid priority inversion by being configured to manage queues of incoming transaction requests.

The constituent components and functions of the entities shown in FIG. 1 will now be further described in the context of an on-line system which will calculate a tariff-based impact for a set of incoming purchase events for market reports. In addition, the system will update a balance of the respective account.

An order of a client is ultimately a purchase event presented by the client to the presentation server 6 using Event Presentation Language or EPL.

In the present example, a purchase event has the following layout comprising five properties or data objects:

Identifier of the product that is being purchased [product_id]

Identifier of the account that is performing the purchase [account_id]

Calculated balance impact [balance_impact]

Time of purchase [time]

Payment method [payment_method]

The following properties of the purchase class will be declared with persistence:

Product_id

Account_id

Balance_impact

Time

The first four above fields are required to produce an itemised invoice, so they will have to be remembered at least until such invoice is produced. Based on such assumptions, a declaration of the purchase event class is shown in FIG. 3.

The following property, instead, will be declared without persistence. The information contained in such properties will be used by the selected algorithm (business process) and then discarded:

Payment_method

With such syntax the class purchase event and its layout is declared. For this example the simplest representation has been chosen and for the sake of simplicity we have declared the whole class as having its persistence managed by one single persistence provider (as declared in the section ‘STORAGE’). A single object, based on a more complex class definition, may be stored/retrieved into/from several independent and heterogeneous persistence providers.

The Event Presentation Language (EPL) is based on XML and with this language it is possible to instantiate any class defined within the domain 1. Therefore the client will have to instantiate a given class using the syntax defined by the EPL. Once the instance is ready, the client will send such instance to the presentation server 6 using preferably a 3^{rd} party message queuing interface.

The client will have to present a purchase event to the enterprise ecosystem running on the apparatus. An example of a XML frame (representing a purchase event) formalised using the EPL is shown in FIG. 4. The layout of the XML frame carrying the information contained in a purchase event strictly depends on the declaration of the purchase event class.

A node manager process checks the syntax and the layout of the incoming frame before the selection of the appropriate event algorithm (business process).

With reference to FIG. 2 a client 7 interacts (does purchases) with the domain 1 via a standard web browser 10. A reseller 9 instead is represented as an enterprise that has a business application already in place. The reseller 9 represents such external business system. Interfaces are represented with the bi-directional block arrows tagged with the capital letters A and B. A first kind of interface, the one tagged with the letter A, between the web browser 10 and the web server 11 will likely transport HTML over HTTP. The interface B between the reseller (business system) and the web server 11 will likely transport XML over HTTP. Last, interface C between any application component hosted by the web server 11 and the domain 1 is to be XML EPL over a reliable messaging protocol as supported by the presentation subsystem 5. There are some cases where it may be convenient to provide an interface between an external business application and the apparatus directly, without a front end infrastructure like the one provided by a web server. In this respect, it is to be noted that even in the architecture shown in FIG. 2, some ‘external applications’ interface with the domain 1 directly already. Such external applications (external to the apparatus) are represented by the services (eg CGI applications and/or Web Services) hosted by the web server itself.

Information about the category of the client (or class of the event being presented to the domain) is encapsulated into the XML frame representing an instance of the class of the event. The selection of the role might be, in this example, supported leveraging the kind of authentication provided by a 3^{rd} party system. For instance, the URL requested by the consumer might reference a CGI (Common Gateway Interface) application that supports authentication based on a standard access control list and/or leveraging other tools available within the operating system environment hosting the web server itself. For the sake of simplicity none of any other of several tools and methods supporting strong authentication will be described.

The definitions of three classes are stored in a master repository 12 (see FIG. 1).

The files containing the classes' definitions are based on XML DDL (a language for the creation of classes of objects).

Purchase_event_ddl.xml

Customer_ddl.xml

Product_ddl.xml

The file purchase_event_ddl.xml contains the declaration of the class purchase_event, the file customer_ddl.xml contains the declaration of the class customer and the file product_ddl.xml contains the declaration of the class product. These files are configured to be input to a specialized tool that provides the parsing and the proper internal representation of the classes into the master repository (or data dictionary).

For this example we have assumed we have two available persistence providers. The first one has been named ‘data_{—}01’ and the second one has been named ‘data_{—}02’. Such persistence providers are referenced into the declarations of the three classes of objects. Using the two different persistence providers, we will declare the classes of objects so that the instances of the class purchase_event will be stored into the data_01 persistence provider while the instance of the classes product and customer will be stored into the data_02 persistence provider.

Turning to FIG. 3 which shows the purchase event class declaration files, such declaration will now be discussed in more detail.

The class is declared to have persistence and to be ‘contained’ by the persistence provider ‘data_{—}01’. This is declared into the section <STORAGE>. In the same section the schema identifier as known by the data source is declared too. Such schema identifier can have different meanings depending on the implementation of the underlying program implementing the persistence provider. In the first embodiment the persistence provider is a relational database engine and the identifier declared within the section <SCHEMA> will correspond to a table name.

The property product_id is declared to be of type OBJ_ID (an internal type within the apparatus forming the domain) and it is declared to have persistence. In the logic used the product_id property is meant to contain the reference (unique identifier) to the product item that is being purchased.

The property account_id is declared to be of type OBJ_ID, too. Like the property product_id it has persistence. The property account_id is meant to contain the reference (unique identifier) of the customer that is purchasing the product referenced by the property product_id.

The property balance_impact is declared to be of type DOUBLE (an internal type within the apparatus) and it is declared to have persistence. The property balance_impact is meant to contain the balance impact generated by the actual purchase against the balance of the customer performing the purchase itself.

The property payment_method is declared to be of type LONG (an internal type within the apparatus) and it does not have persistence. Any field that does not have persistence will not be forwarded to the underlying persistence providers at the end of a transaction. This kind of property (without persistence) can be used when the contained information is necessary only to the logic by which it is consumed (eg a business rule within a business process) but there is no requirement for durability. For instance, whenever an event has to be transformed into another class instance (or into a set of classes' instances) there might be no requirement to store all the properties of the original event into the persistence providers.

The property time is declared to be of type TIMESTAMP (an internal type within the apparatus). Such type is meant to contain time information. With this kind of type it is possible to formalize a time period or a date. In the logic of our example this property contains the information about when the purchase happens.

FIG. 6 shows the product class declaration.

The XML DDL document shown in FIG. 6 declares a class named ‘product’ that has the following properties:

Description

Price

The class product has been declared so it will be forwarded to the persistence provider ‘data_{—}02’. This means that the persistence of the instances of this class will be provided by a system different than the system providing persistence to the instances of the class purchase_event. In this example the first persistence provider (data_01) will be used to store all the incoming purchase events. For this reason, the data01 persistence provider is set up to support a typical OLTP (on-line transaction processing) type of operations. On the other hand, the set of products on offer very likely will not be updated with an extremely high frequency. Instead the persistence provider containing the products' instances will be mainly accessed in order to retrieve the prices of all the defined products. For this reason, the database containing the products provides a typical and simple OLAP (on-line analytical processing) service. So, the declaration of these classes allows configure each persistence provider in the proper way.

The property description is declared to be of type STRING (an internal type within the apparatus). This property is meant to contain a short description (30 characters) of the item represented by an instance of the class product. The property description has persistence.

The property price declared as DOUBLE (an internal type within the apparatus) and with persistence is meant to contain the price of the items represented by the instances of the class product.

The DDL document shown in FIG. 7 declares a class named ‘customer’ that has the following properties:

Username

Password

Balance

The class has been declared so that the persistence of all the instance that belong to such class will be provided by the persistence subsystem ‘data_{—}02’.

The property username is declared to be of type STRING and has persistence. This property is meant to contain the username of a customer.

The property password is declared to be of type STRING and has persistence. The property password is meant to contain the password assigned to a customer. The property balance is declared of type DOUBLE and it has persistence. This property is meant to contain the whole amount to any expenditure done by a customer. The value contained into this property will be updated any time the customer will purchase an item.

Each node manager 2 within the domain 1 references a look-up table (not illustrated) which is stored in the master repository 12 from which, given a particular class of event, in this case a purchase event, and a given category of client (eg customer or reseller), a corresponding reference to an event algorithm or business process (a piece of logic comprising one or more operations which may modify existing data, create new data or interact with another system) is executed.

Based on the look-up table implementing ternary associative logic the appropriate event algorithm can be retrieved in response to the clients' role and to the category of the received event. For reasons of simplicity only one class of event will be considered, namely that of a purchase event.

FIG. 8 illustrates the situation when the consumer agent presents a purchase event, the node manager software is able to determine a relationship between the role consumer, the class purchase and the event algorithms Consumer_purchase. The business process can contain several business rules implementing the logic that has to be triggered by the purchase event. Such logic is labelled ‘Consumer_Purchase’. When the reseller agent presents the purchase event, the node manager software will ultimately execute the logic into the Reseller_Purchase event algorithms. In the picture such logic is represented with the box labelled ‘Reseller_Purchase’.

Using ternary associative logic it is possible to implement the two different logics into two well-contained processes or sets of operations. The selection of the proper event algorithms, and thus the proper logic, is responsibility of the node manager software.

In our example, the enterprise sells the following products:

Telecom report

Automotive report

Oil and Gas Report

Manufacturing report

Retailing report

The currency used for the price of each report item is US dollars and for the sake of this discussion no currency conversion issue is considered. In a real scenario, very likely the event algorithms should be extended with one or more business rules dealing with real-time currency conversion. The prices assigned to the reports are completely theoretical.

FIG. 9 shows a list of the available products stored in one of the persistence providers 3 (as defined using XML EPL.) Such product objects are stored into the persistence provider data_02 (as based on the product class definition) and are thus global objects available to any event algorithms within the domain 1.

As can be seen from the document shown in FIG. 9 the listings contains five different objects that belong to the class product (as declared in the section <OBJECT>). The instantiation of each object contains the values for the properties description and price. The table of FIG. 11 summarises the prices assigned to the product objects.

For each instantiated object a unique identifier is created automatically by the apparatus. The table shown in FIG. 10 shows the list of the returned unique object identifiers.

In a preferred embodiment the unique object identifier represents a global unique 5 identifier (GUID) or Universal Unique Identifier (UUID) as defined into the Open Software Foundation (OSF) Distributed Computing Environment DCE documentation. See eg DEC/HP Network Computing Architecture Remote Procedure Call Run Time Extensions Specifications version OSF TX 1.0.11. All the object unique identifiers are calculated by the node manager software whenever a new object is created in the first memory.

FIG. 12 shows a listing of a XML EPL document containing the instantiation of five customers, their user names being:

Customer_01

Customer_02

Customer_03

Customer_04

Customer_05

FIG. 13 shows a table of unique object identifiers which correspond to each customer, the unique identifiers being created by the node manager software.

On receiving an incoming purchase event sent by a client the node manager software parses the data-frame of the purchase event and in so doing ascertains both the class of the event (ie a purchase event) and the role of the agent presenting the event (ie consumer or reseller). Before triggering the respective event algorithm (business process) to process the purchase event, the node manager software retrieves the layout of the class purchase in the form of the declaration data.

The layouts of all the defined classes (the declaration data) is already available from the master repository 12 before the event algorithms is initiated, ie all the layouts of the classes are retrieved form the data dictionary (or master repository 12) when the software node manager starts.

The node manager software then applies ternary associative logic (as defined into the repository that contains the definition of all the available business processes) in order to retrieve the appropriate business process for the processing of the incoming event. To do so, the node manager software compares the class of the event and the role of the agent presenting the event to a look-up table that contains all the ternary associations (class, role, business processes) valid within the domain of the node manager itself.

The ternary association is already available from the master repository 12 before the processing of the incoming event, i.e. the look-up table defining all the ternary associations is retrieved from the master repository when the software node manager starts.

The workflow manager software (part of the node manager software) then loads the data of the purchase event into a memory stack which is accessible by any business rule (or operation within a selected event algorithms) within the business process that is being executed.

Each business rule contained in the selected business process is then executed from the proper libraries in the order defined in the sequence of the business process by the Workflow Manager into the node manager. The workflow manager is also responsible to asynchronously activate any defined infrastructure business rule whenever required.

FIGS. 14A and 14B show a listing of the logic that is contained by the business rules to process a purchase event. The logic of the business rule shown in the listing has been divided into sections A through J for the purpose of explanation. Section A is a synopsis of the algorithm.

The w_stack argument is a pointer to a wl_workflow_stack object. This object, ultimately passed to the function from the Workflow Manager of the node manager exposes a set of interfaces that allows the business rule to access all the needed objects populating the domain. The main interfaces used in this case are LOAD and TEMP_LOAD.

The LOAD interface is the main support for determinism. For any object firstly accessed via this method a lock manager processor implements a domain-scoped global lock to synchronize all the other business processes running on any node manager (within the same domain) that might need to access the same object.

The second argument is a reference to a wl_object_id object. Such object encapsulates the unique identifier of the event that has triggered the event algorithms of which the current business rule is part. The event in question will be an instance of the class purchase_event, so this argument will reference the unique identifier of an instance of such class. Using the interfaces exposed by the wl_object_id class it is possible to obtain the class identifier and the unique identifier of a given object. This argument is ultimately passed to this function by the Workflow Manager (part of the Node Manager) triggering the business rule.

The third argument is a reference to an instance of the class wl_client. This argument is passed to the algorithms (business rule of the event algorithms that has been triggered by the Workflow Manager) and it contains a set of properties that uniquely identify the client agent that has presented the event to the apparatus.

The remaining four arguments are not passed to the function by the Workflow Manager. Instead they have been used in order to make this function re-usable from two different business rules: the former devoted to process an event present by an agent impersonating the consumer role and the latter devoted to process an event presented to the apparatus by a client agent impersonating the reseller role. The arguments purchase, account and product will reference, respectively, the wl_object instances representing the incoming purchase event, the customer doing the purchase and the product that is being purchased. The last argument contains the percentage of the discount (accordingly to this simple example) that has to be applied to the purchase. For the sake of this example, the only difference between a purchase performed by a reseller and the purchase performed by a consumer is the applied discount: a reseller will be granted a 5% discount while no discount will be applied in the case of a purchase performed by a consumer.

Section B relates to the workflow manager (part of the node manager software), before triggering the algorithm proper, pushing the incoming event into a memory stack (wl_workflow_stack) that will be accessible by any other business rules that will be executed since this moment on. Before any rule can access the properties of any global object the object has to be loaded into a local stack of a node (or data processor) provided and maintained by the Workflow Manager (part of the node manager software). This operation is performed activating the method ‘LOAD’ exposed by the workflow stack. The load method will automatically provide synchronization amongst all the node managers running within the same domain: once an object is ‘loaded’ in the local stack of the Node Manager for use by an event algorithms it can be accessed only by a business rule within the same instance of the event algorithms. Only once all the operations of the algorithm within the same business process have been fired, the objects committed to the persistence providers (if those objects have persistence) and such objects are freed from any global lock so they become available to other business processes on the same or any other node manager within the same domain. In the case an object has not to be modified by the algorithm accessing it there is a more convenient alternative to the load method. The product object will be accessed by the algorithm using the method ‘TEMP_LOAD’. In this case the product object will be accessed only to retrieve the information about the product price. In this respect the product object can be seen as if it were a read-only object. For this reason it is not necessary to put a global lock on the product object.

Section C shows how the event algorithm has access to some properties of the incoming event in order to retrieve the object identifier of the customer doing the purchase and the object identifier of the product that is being purchased, i.e. the reference to the account_id property and the reference to the product_id property.

The account_id property and the product_id property are referenced using an interface exposed by the class wl_Object. After the business rule has loaded the incoming purchase event, it references the needed properties using the method PTR_GET. PTR_GET copies a variable into a register of the Workflow Manager which is used by the algorithm. The argument of such method is a string. INT means Internals. In the first embodiment of the invention, the layout of a class is always organized into an INTernal part and into an EXTended part. The account_id is the identifier of a property that has been defined within the INTernal part. The dot is just a syntactical separator. INT.account_id has so to be read as: the property named ‘account_id’ that has been defined within the ‘INTERNAL’ part of the class.

Sections D and E are indicative of operations to load the product object and the account object into the stack provided by the Workflow Manager. Like the incoming purchase event, the account object is loaded by requesting the Workflow Manager to copy the data to the stack. The product object is loaded into the stack calling the method ‘TEMP_LOAD’ of the stack. This is because, according to this simple example, the product object is considered to be a read-only object. For this reason no synchronization is necessary when accessing the product object. Using the temp_load method, whenever synchronization is not needed, results in better performance (in this case the global lock manager agents within the domain are not involved in a request initiated by the temp_load method).

Section F shows the price of the product item and the current balance of the account are obtained.

The appropriate properties of the objects (i.e. price and balance) are obtained with the method ptr_get exposed by the wl_object class on which those properties are loaded into appropriate register.

Section G shows the code broken down into a set of steps. In order to get the value of a referenced property (in this case the price) the algorithm activates the method PTR_GET_DATA.

Eventually, after the impact has been calculated, such impact has to be added to the current balance of the customer. This is done with the code a section H.

The code at section I performs the operation of storing the balance into the account. Here one can observe that the newly calculated balance is stored into the account object using the method PTR_SET_DATA. Once the new balance is stored into the account object the object is stored into the stack using the stack interface store. To store the object back into the stack is necessary to propagate any change performed against the object (as stored into the stack) to the underlying persistence providers (eg relational database engines) which is performed automatically by the workflow manager at the completion of the business processes participating to the transaction.

Finally, section J is operative to update the purchase event object.

The node manager software is finally operative to store details of the purchase event to data_01, and to cause the information relative to requested product and the current transaction (accordingly to the logic defined for this simple example) to be sent back to the client.

The code listing shown in FIG. 15 shows the full implementation of the algorithm that has to be applied whenever a consumer performs a purchase.

In the first embodiment of the invention, the presented algorithm is a C++ function that will be triggered due to the incoming event. It is to be noted that the purchase_event_logic will be called passing the discount argument set to 0.0.

This algorithm will be triggered by any incoming purchase event that has been presented to the apparatus by an agent that is not impersonating the reseller role.

FIG. 16 shows the code in which the full implementation of the algorithm to be applied whenever a reseller performs a purchase.

This algorithm has been copied from the algorithm implemented for the consumer role shown in FIG. 15. The only difference is the value assigned to the variable discount, passed to the function purchase_event_logic.

As previously discussed the node managers are configured so that, as soon as a client presents an event of the class purchase_event the appropriate business process will be triggered. The business process will be triggered not only depending on the class of the incoming event but also on the role impersonated by the agent that is actually presenting the event. In this case, as soon as a purchase_event is presented to the node manager, depending on the role of the client, the node managers have to trigger one of the two algorithms purchase_event and purchase_event_reseller. More precisely, the purchase_event_reseller will be triggered whenever the client is impersonating a reseller. The event algorithm purchase event will be triggered in all the other cases (such as when the client is impersonating a consumer).

FIG. 17A shows the configuration file that will formalise the required associative logic.

For the sake of this sample example, the only business processes hosted by the node managers are:

Purchase_reseller

Purchase

The purchase_reseller event algorithm will contain just one business rule (purchase_event_reseller). The same, the business process purchase will contain just the business rule purchase_event.

The first section of the configuration file references all the rules libraries that have to be used. A library is essentially a container of one or more business rules. A library can be mapped into a DLL or into a run-time shared library. For instance, we assume we have put both the two business rules we have seen before into a single DLL that we have called roadmap.dll. This first section will tell the node managers that there is one available, that it has to be referenced using the mnemonic ‘roadmap’ and that its absolute path is c:\develop\warelite\distribution\roadmap.dll.

Technically a library is a binary file (for instance, a DLL). As such it is a component that can be referenced with a file absolute path. Also, it is a component that has to be referenced easily within the Workflow Configuration file itself: a business rule will also be contained into a library, so to fully reference a business rule it is necessary to formalize that a specific business rule belongs to a specific library. This is quite important, actually two business rules with the same name (but defined into two different libraries) can contain a completely different logic. So a business rule is always fully identified by a mnemonic identifier referencing a library followed by the name of the function (defined within the library) that implements the business rules itself.

A library is thus declared using the following attributes:

name

mod

dir

Also, in order to support the software distribution process of any third party providing business rules and workflows there is a fourth attribute. This attribute is called key. The key attribute is meant to contain a string that can be used by the logic contained into a library to verify if the user of the library is authorized to use the library. How the value (a string) assigned to the attribute key is used is complete responsibility of the software provider. Whenever a library is loaded, the run-time environment will pass such string to a special function (that can be defined into the library). With such function (wl_lib_auth) the software vendor providing the library can deny or authorize the usage of the library itself.

The second section (entitled ‘workflow declaration with ternary associative logic’) declares the two business processes purchase and purchase_reseller.

The first line of the second section starts with the declaration of the name of the business process. It continues declaring the association between such business process and a class of objects. The tag ‘role’ is meant to declare the relationship between the business process and a role (in this case the association is with the role ‘reseller’). The body of the event algorithms (starting nested within ‘{’ and ‘}’) contains the sequence of all the business rules forming the business process. In this case there is just one business rule and it is referenced using the mnemonic name of the library where it resides and its name, as defined internally to the library itself. So, roadmap.purchase_event_reseller references the function purchase_event_reseller as defined into the library ‘roadmap’.

FIG. 18 shows an example of a purchase event frame in which a customer has requested a report. FIG. 19 shows a purchase event frame similar to that of FIG. 18 but in which the customer is impersonating the reseller role.

FIG. 20 shows an example of a configuration repository for the Global Lock Managers in a domain, expressed with a specific syntax valid within the apparatus.

The configuration repository is transformed into a set of suitable data structures and maintained in a first memory by each node manager within the apparatus. In a preferred embodiment of the invention, each node manager loads such configuration at start-up time.

As shown in the example, the syntax that has been adopted allows to identify each lock manager by specifying its mnemonic name, its IP-address and its IP-port. This is done within the lines starting with the prefix ‘GLM:’.

Each lock manager declared with the line starting with the prefix ‘GLM:’ has then to be associated to a set of classes of objects for which a global lock request might be sent by any node manager within the same domain. The relationship lock manager classes of objects are established by declaring a set of classes within the body of each lock manager declaration (starting with ‘{’ and ending with ‘}’) and by using the token ‘class’. The token ‘class’ is meant to declare one or more classes.

Accordingly to this example, all the lock requests targeting the class purchase_event will be received and processed by the lock manager identified with the mnemonic name GLM_01 whilst all the lock requests targeting the class product will instead be received and processed by the lock manager identified by the mnemonic name GLM_02.

FIG. 21 shows a further embodiment of the invention which comprises two domains 21 and 22. The domain 21 comprises a lock manager processor 24 and two node manager processors 25. Two persistence providers 26 and 27 are associated with the domain 21. The domain 22 comprises two lock manager processors 28 and 29 and three persistence providers 32,33 and 34. A unified data interface 30 between the node managers and objects 23 of the persistence providers is provided supporting Data Declaration Language (DDL) and Event Presentation Language (EPL). An internal bus 31 provides communication to the persistence providers via the unified data interface 30.

The advantages of the above-described inventive networks include the following:

Since the workflow manager retrieves and loads into the stack memory any data that the algorithms need to act upon, such operations do not have to be included in the event algorithms. Since the node manager software, using the various class declarations, controls the persistence of the various data objects involved into a transaction, the event algorithm does not need to control persistence. Since the node manager software acts as a transaction coordinator this means that the event algorithm does not need to take account of such. The node manager software and the lock manager software provide synchronization and determinism amongst all the business processes within the same domain, so that the event algorithms do not have to perform such operations.

Importantly, therefore, there is a clear distinction between what one may term infrastructure logic and the business logic, and so facilitating development, deployment and extension.

Importantly, therefore, any client agent has not to be aware of the logic that will be applied by the apparatus, being such logic not referenced within the data frame being presented by the agent itself, and so facilitating integration and extension.

Since the node managers are independent units processing transactions coordinated by one or more lock managers, the overall capacity of the apparatus can be increased by adding more node managers without any impact on the business logic, and so facilitating incremental horizontal scalability. Reference is now made to FIG. 22 that shows the equipment that has been used to run a performance/scalability test based on the earlier example of incoming purchase events for market reports.

S1 and S2 are the two available subnets. They have been implemented using two Fast Ethernet Switches. The following table gives the details for the hardware equipment used in the test.

| Name | Spec |
|---|---|
| S1 | Netgear Fast Ethernet Switch FS108 |
| S2 | Netgear Fast Ethernet Switch FS108 |
| LM001 | HP e-PC |
| | Pentium 4 2.0 Ghz 400 Mhz FSB |
| | 768 MB RAM |
| | Fast Ethernet |
| | 20 Gb HD (ATA 5400 rpm) |
| NM001 | DELL Dimension 4500 |
| | Pentium 4 2.53 Ghz 533 FSB |
| | 256 MB RAM |
| | 2 Fast Ethernet |
| | 40 Gb HD (ATA 7000 rpm) |
| NM002 | Based on Gigabyte GA-7VRXP |
| | AMD Athlon 1800+ (1.53 Ghz) 200 FSB |
| | 256 MB RAM |
| | 2 Fast Ethernet |
| | 60 Gb HD (ATA 7000 rpm) |
| DIM11 | COMPAQ Evo D-310 |
| | Pentium 4 2.0 Ghz 400 FSB |
| | 768 MB RAM |
| | 3 Fast Ethernet |
| | 40 Gb HD (ATA 5400 rpm) |
| DB001 | Based on Gigabyte GA-7VRXP |
| | AMD Athlon 1800+ (1.53 Ghz) 200 FSB |
| | 768 MB RAM |
| | 1 Fast Ethernet |
| | 60 Gb HD (ATA 7000 rpm) × 5 |
| KVM | Hub, Cables, Monitor, Keyboard and mouse |
| Cat 5 Cables | Various Manufacturers (tested and fully Cat 5 compliant) |

The computers LM001, NM001, NM002 and DIM11 have been configured so that whenever a Node Manager (on NM001 or NM002) needs an exclusive access to a global object it sends a request to the Lock Manager running on LM001. The configuration repository (for the global locks) has been installed locally on LM001 and it is accessed remotely by the computers NM001, NM002, DIM11. Libraries containing the business rules used in the business processes and the configuration repository for the business processes themselves have been installed on LM001 and are accessed remotely by the computers NM001, NM002, DIM11.

The Node Managers running on LM001, NM001, NM002 and DIM11 have been configured in order to run four business processes concurrently (four threads).

The computer DB001 has been configured to run the relational database engine in order to accommodate the requirements (persistence providers) of the example application, as discussed previously. For this test, Microsoft SQL Server 2000 has been used. The disks on DB001 have been configured with RAID 0 (stripe mode) in order to have two physical partitions (each formed by a couple of hard disks), one for data and one for logs.

The figures below show the results from running the example application using from one node manager to up to four node managers. Such figures are particularly important to determine the degree of decay when adding more Nodes Managers. The test has been performed presenting batches of 220K (two hundred twenty thousands) events. In order to present the events, the tool wl_mq_send has been used. The tool has always been run on DIM11. The persistence providers hold 220K (two hundred twenty thousands) customer objects and 2K (two thousands) product objects.

The performance measurements have been taken using the Microsoft Performance tool connected to Microsoft SQL Server 2000. In this way it is possible to count (per second) all the transactions against the persistence provider holding the customers' account balances. A transaction against the customer balance account, as said previously, represents the completion of a business processes' task initiated by one single event.

The figures presented in the following table represent the minimum capacity (average) obtained by running the same test several times.

| | DIM11 | NM001 | NM002 | LM001 | Total |
|---|---|---|---|---|---|
| E/S (1 N.M.) | 30 | — | — | — | 30 |
| E/S (2 N.M.) | 30 | 30 | — | — | 60 |
| E/S (3 N.M.) | 30 | 30 | 30 | — | 90 |
| E/S (4 N.M.) | 30 | 30 | 30 | 30 | 120 |

E/S = Event Per Second
N.M. = Node Manager

The figures presented in the following table represent the maximum capacity (average) obtained by running the same test several times.

| | DIM11 | NM001 | NM002 | LM001 | Total |
|---|---|---|---|---|---|
| E/S (1 N.M.) | 34 | — | — | — | 34 |
| E/S (2 N.M.) | 34 | 34 | — | — | 68 |
| E/S (3 N.M.) | 34 | 34 | 34 | — | 102 |
| E/S (4 N.M.) | 34 | 34 | 34 | 34 | 136 |

E/S = Event Per Second
N.M. = Node Manager

The inventive apparatus finds utility in many areas and the following provides examples of events for which the inventive apparatus could advantageously be employed:
Logistics
   RFID (Radio Frequency Identification) signal
   BarCode signal
   Inventory Update (e.g. goods in, goods out)
   Inventory Check Request
   Inventory reaching watermark
   Submission of Bill Of Material (BOM)
   BOM Update
   Request for Purchase
   Supplier Subscription
   Start of Shipment
   Fleet Position
   Package Position
   Truck break-down
   Delivery Notification
   Fleet Fuel Consumption
Manufacturing
   RFID signal
   Bar Code Signal
   Machinery Sensors Signals
   Components Pool in Production
   Machinery Production Line Status
   Machinery break-down
   Production Cycle Completion
   Inventory Update
   Customer/Distributor Order
   Recipe Change
   BOM Change
   Material Price Change
Financial Services
   Request for Quote
   Request for Info
   Customer Complaint
   Stock Purchase
   Stock Sell
   Position Change
   Customer Details Update
   Money Transfer Request
   Payment Received
   Account balance change
Telecommunications
   Telephone Call
   SMS/MMS
   Data Transmission
   Request for Info
   New Service
   Field Service Request
   Field Service Completion
   Service Purchase
   Tariff Change
   Payment Received
   Customer Position
   New Marketing Campaign
   New Contract Opening
   Contract Closure
   SNMP (Simple Network Management Protocol) Signal
Utilities
   Request for Quote
   Request for Info
   Customer Complaint
   Stock Purchase
   Stock Sell
   Customer Details Update
   Money Transfer Request
   Tariff Change
   Usage Update
   New Contract Opening
   Contract Closure
   Field Service Request
   Field Service Completion
Retail
   RFID Signal
   BarCode Signal
   Inventory Update (e.g. goods in, goods out)
   Inventory Check Request
   Till Sales Registration
   Request for Purchase
   Request for Info
   Consumer Subscription
   Consumer Exchanges Request
   Consumer Complaint
   Start of Shipment
   Delivery Notification
   Payment Received

The following provides examples of business scenarios that the inventive apparatus can execute upon occurrence of the events above mentioned:
Event: RFID/BarCode Signal
   Manufacturing
      Real time, event driven supply chain execution—from client order and/or from production line to extended/virtual inventory check, to inventory replenishment, transportation etc
      Real time visibility over retail sales
      Vendor managed inventory
   Retail
      Real time, event driven supply chain execution (as above)
      Sales of value added services to suppliers—i.e. real time visibility over sales of their goods (as above)
      Efficient consumer response—in real time
      Real time in-store marketing
      Trade promotion management (TPM)
   Logistics
      Sales of value added services for real time supply chain execution (as above)
      Real time package delivery tracking
   Airports
      Real time luggage tracking
   Healthcare
      Drugs/tools total traceability
Event: SNMP Signal
   Telcos (Internet Service Providers)
      Real time rating, billing & marketing (e.g. send customers new offers as soon as they reach a given usage watermark)
      Real time network monitoring, problem response, adjustment (i.e. breakdown events trigger self repair procedures, switching to back-up/alternate route, engineer intervention scheduling etc.)
      Real time global service scheduling
      Real time SLA (Service Level Agreement) monitoring & adjustment
      Real time usage monitoring & djustment
Event: position change
   Financial services
      Real time position keeping
Event: stock sale/purchase
   Financial services
      Straight through processing (i.e. real time transaction settlement and reconciliation)
   Utilities
      Flow through provisioning
Event: Money transfer request
   Financial services
      Real time clearing house processing

The inventive apparatus provides business benefits to both final users enterprises and to service providers:

Final user enterprise benefits
No requirement to compromise between business requirements and packaged applications capabilities
   Eliminating or substantially reducing the need to map business requirements onto packaged applications and to compromise on what the enterprise really needs
Eliminating or substantially reducing expensive applications customisation
Responding in real time to any kind of event—eliminate exception management
   No requirement to adopt a manual approach for exceptional events—just define what the enterprise's business response should be and automate it with the inventive system.
Creating flexibility
   Change the enterprise's processes by simply changing/adding business rules
Re-using existing software infrastructure
   Re-using existing database engines, messaging systems etc
Use of inexpensive hardware
   Use small, cheap computers to run all the enterprise's business logic; buy new ones only when the enterprise's processes need more capacity
Keep existing applications—without significant financial outlay for EAI (Enterprise Application Integration) tools and services
   Implement inventive system as an exchange hub in a short period.
Eliminate or substantially reduce expensive application upgrades
   Processes can be modified as the enterprise's strategy changes
Facilitating application upgrades
   No requirement to make significant alterations when legacy applications are being upgraded: just modify the business rules that coordinate the legacy applications within the inventive system
Eliminating or substantially reducing down-time
   The enterprise's processes can be kept running whilst those processes are being modified
Possibility for users of the inventive system to become a real time enterprise with an incremental approach
   New processes and new infrastructures can be incorporated to increase the enterprise's level of automation.

Service Provider Benefits
Simplifying and speeding-up the development of solutions
   As scalability, determinism, transaction co-ordination and persistence management are already being taken care of by the inventive system, WL RTPD′(Real Time Process Design and Deployment) methodology enables the design & implementation of processes in a short period (for example in a few days)—making it possible to manage a large number of small customers at fixed prices while maintaining profitability
Scaling-up or scaling-down solutions with no additional coding required
   Large projects are designed and implemented in a very similar manner to smaller ones—leveraging the inventive system significant scalability services. As the duration of a project can generally be easily forecasted, it is possible to propose fixed prices to both small and large customers
Re-using solutions
   Customers' solutions are made of re-usable, configurable roles, objects, business rules. It is possible to create libraries to quick-start any new project and it's easy to create commercial solution development toolkits/solution suites for given sectors/business areas
Changing solutions easily and quickly
   Customers can be enabled to change as times change by simply modifying existing business rules, adding new business rules to existing processes, designing new processes with the RTPD′methodology, scaling up the inventive system's infrastructure by adding more nodes
making application hosting a viable business
   The inventive system provides a framework for hosting business solutions that cuts upfront investments, enabling application service providers to grow their infrastructure as their business grows

1. A computer network for processing received event data, the computer network comprising a plurality of data processors, each data processor being provided with a node management program, the computer network further comprising shared data storage means which is accessible and shared by the data processors, the shared data storage means being provided with (a) declaration data which is representative of where data objects are stored, and whether data objects resulting from processing of event data are to be stored and where such data objects are to be stored, (b) event algorithms and (c) a look-up table which indicates which event algorithm is associated with (i) a category of agent originating the event data and/or (ii) a category of event, a data processor being such that, in use, the node management program determines (i) the category of agent which originated the event data and/or (ii) the category of the received event data, retrieves declaration data from the shared data storage means, by use of the look-up table determines a respective event algorithm which is associated with (i) the category of the agent which originated the event data and/or (ii) the category of event data, the node management program also being operative to call data objects required by the selected event algorithm, the node management program locating said data objects in said shared data storage means from location data included in the declaration data, and the node manager program being operative to store any data objects resulting from the execution of the algorithm which are to be stored as required by the declaration data, in one or more respective locations in the shared data storage means as determined by the declaration data.

2. A computer network as claimed in claim 1 in which data objects are objects of data which an event algorithm is required to process/act on.

3. A computer network as claimed in claim 1 in which the declaration data is loaded onto a local memory of a data processor before an event algorithm is determined and then called.

4. A computer network as claimed in claim 1 in which the declaration data comprises a dictionary of characteristics of all data objects within the network.

5. A computer network as claimed in claim 1 in which the look-up table is stored in a part of the shared data storage means which is remote from the data processors, and the data processors communicating with that part of the shared data storage means by an external connection.

6. A computer network as claimed in claim 1 in which the algorithms are stored in a part of the shared data storage means which is remote from the data processors, and the data processors communicating with that part of shared data storage means by an external connection.

7. A computer network as claimed in claim 6 in which that part of the shared data storage means is read-only memory.

8. A computer network as claimed in claim 1 in which data objects are stored in a part of the shared data storage means which is remote from the data processors, and the data objects resulting from the execution of the algorithm which are required to be stored by the declaration data, in a respective location as also determined by the declaration data.

9. A computer network as claimed in claim 1 in which that part of the shared data storage means which contains objects which are not alterable as a result of an event algorithm is a read-only memory, and that part which contains objects which may be modified as a result of an algorithm is a re-writable memory.

10. A computer network as claimed in claim 1 in which the data processors communicate with the shared data storage means by an external connection.

11. A computer network as claimed in claim 1 in which each data processor is configured to retrieve declaration data which is representative of all the defined data objects included in sequences of business rules defining all the available event algorithms.

12. A computer network as claimed in claim 1 in which all data objects to be acted on by the event algorithm are stored in a local memory of the data processor which comprises a memory stack which is adapted to be accessible by the algorithm.

13. A computer network as claimed in claim 1 in which said data obtained by the node management program from the data storage means comprises most of the data which is to be acted upon by the event algorithm, which is in addition to the data included in the event.

14. A computer network as claimed in claim 1 in which each instance of a given class of a data object may be stored on several different persistence providers of the shared data storage means and/or all the instances of different classes of data objects can be stored on several different persistence providers.

15. A computer network as claimed in claim 1 which comprises at least one lock manager processor which is connected to the data processors, and is configured to control use and modification of predetermined data objects requested by the data processors.

16. A computer network as claimed in claim 15 in which access to those data objects which are intended to be modified/updated by an event algorithm is controlled by the lock manager processor which is operative to allow access to one such data object by only one data processor at any one time.

17. A data processor for a network of computers which is configured to receive and process received event data, the data processor being provided with a node management program, and the data processor being configured to be linked to shared data storage means which is shared by a least one other such data processor of the network of computers, the data storage means being provided with (a) declaration data which is representative of where data objects are stored, whether data objects resulting from processing of event data are to be stored and where such data objects are to be stored in the shared data storage means, (b) event algorithm and (c) a look-up table which indicates which event algorithm is associated with (i) a category of agent originating the event data and/or (ii) a category of event, the data processor being such that, in use, the node management program determines (i) the category of agent which originated the event data and/or (ii) the category of the received event data, retrieves declaration data from the shared data storage means, uses the look-up table to determine a respective event algorithm which is associated with (i) the category of agent that originated the event data and/or (ii) the category of event data, the node management program also being operative to call data objects required by the selected event algorithm from one or more locations in the shared data storage means as stated in the declaration data, and the node management program being operative to store any data objects resulting from the execution of the event algorithm which are to be stored as required by the declaration data, in one or more respective locations in the shared data storage means as determined by the declaration data.

18. A machine readable data carrier which is provided with instructions to implement a node management program on a data processor (2) in a computer network (1), the computer network comprising a plurality of such data processors, the computer network further comprising shared data storage means (3) which is accessible and shared by the data processors, the shared data storage means being provided with (a) declaration data which is representative of where data objects are stored in the shared data storage means, and whether data objects resulting from processing of received event data are to be stored and where such data objects are to be stored, (b) event algorithms and (c) a look-up table which indicates which event algorithm is associated with (i) a category of agent which originated the event data and/or (ii) the category of the received event data, the node management program being operative to cause a data processor to determine (i) the category of agent which originated the event data and/or (ii) the category of the event data, and accordingly determine an associated event algorithm from the look-up table, the node management program being operative to call the declaration data and the node management program being operative to call data objects from the shared data storage means which objects are required by the event algorithms, the node manager program locating said data objects in said shared data storage means from location data included in the declaration data, and the node management program causing data objects resulting from the execution of the event algorithms which are to be stored in accordance with the declaration data in a respective location as determined by the declaration data.

19. A method of processing received event data comprising causing a data processor from a network of data processors to determine (i) a category of agent which originated the event data and/or (ii) a category of the event data, determining a respective event algorithm by means of a look-up table which indicates which event algorithm is associated with (i) and/or (ii), to retrieve from shared data storage means, which data storage means is shared by the data processors, declaration data which is representative of where data objects are stored in the shared data storage means, to retrieve the selected event algorithm from the shared data storage means, to call data objects required for execution of the event algorithm from the shared data storage means from one or more locations determined by the declaration data, and, to store any data objects resulting from execution of the algorithms which are to be stored as required by the declaration date in one or more locations in the shared data storage means determined by the declaration data.
